(19) United States
(12) Patent Application Publication
(10) Pub. No.: US 2008/0057148 A1
(43) Pub. Date: Mar. 6, 2008

(54) Extrusion die for forming polymeric foam sheets

(76) Inventors: Dale P. Pitch, Jim Falls, WI (US); Edward C. LeDuc, Bloomer, WI (US)

Correspondence Address: MCCRACKEN & FRANK LLP, 311 S. WACKER DRIVE, SUITE 2500, CHICAGO, IL, 60606, US

(21) Appl. No.: 11/511,734

(22) Filed: Aug. 29, 2006

(51) Int. Cl. B29C 47/12; B29C 47/00; B29C 47/90

(52) U.S. Cl. 425/380; 425/381.2; 425/464

(57) ABSTRACT

An extrusion die for forming polymeric foam sheets includes a first die body, a second die body, and a manifold within the first die body and the second die body, wherein the manifold includes an inlet to receive polymeric material. The extrusion die further includes a die exit formed by opposing die lips in fluid communication with the manifold and a temperature control zone adjacent the die lips. The extrusion die further includes two generally planar shaping surfaces in proximity to the die exit and place one above and one below the die exit. Adjustable shoes are disposed in proximity to the die exit on each side of the die exit and between the planar shaping surfaces.

### CROSS REFERENCE TO RELATED APPLICATIONS

Not applicable

### REFERENCE REGARDING FEDERALLY SPONSORED RESEARCH OR DEVELOPMENT

Not applicable

### SEQUENTIAL LISTING

Not applicable

### BACKGROUND OF THE INVENTION

1. Field of the Invention

This invention relates to an extrusion apparatus and more particular to extrusion dies for extruding polymer foam sheets.

2. Description of the Background of the Invention

An extrusion die is used to extrude molten thermoplastic or polymeric material into a relatively thin film or sheet. Conventional extrusion dies have a die cavity with the general shape of a coat hanger. These extrusion dies have been generally referred to as coat hanger dies. Typical coat hanger dies include an inlet, an inlet manifold, a generally triangular shaped preland portion, a melt well, and a die exit or gap. In these dies, a back edge of the preland portion includes linear edges that form a taper converging towards a die entrance. The preland portion provides a resistance to flow that varies over the width of the die to uniformly spread the polymeric or thermoplastic material across the entire die.

Extrusion dies are generally large and expensive machines. It has been desirable to create extrusion dies that can create various sizes and shapes of extruded products, as opposed to one or two sizes and/or shapes of extruded products. For example, one extrusion die includes die blocks attached to opposite ends of the extrusion die, wherein each die block includes a pivot arm mounted thereto. Each of the pivot arms includes a pivot arm seal that can be extended into a die opening at various different positions or retracted into the respective die block. The positions of the pivot arms and the pivot arm seals control a thickness of an extruded product in a y-direction, but do control a width of the extruded product in an x-direction.

Another extrusion die is adapted to extrude foam to create foam boards and the like. The die includes a pair of die lips attached to a die body. The lips are fastened to the die body in such a way that they may be adjusted to form a uniform gap, to close the gap more in the center than at ends thereof, or to open the gap more in the center than at the ends. The adjustability of the die lips allows for an extruded foam board of uniform thickness or a foam board having different thicknesses throughout.

Yet another extrusion die for extruding thermoplastic foam therefrom includes an extruder affixed to the die for supplying heat plastified extrudable foam material to the die. The die is in operative communication with the extruder, wherein the die terminates in an elongate extrusion orifice. The extrudable foam material is extruded from the die between a pair of generally parallel and opposing forming plates. Curved supports are disposed at opposite ends of the die opening adjacent edges of a freshly extruded foam sheet.

A further extrusion die for extrusion of foam therefrom includes an orifice from which extruded thermoplastic foam is extruded. The die further includes a foam shaping apparatus having a pair of opposing upper and lower generally planar members each having diverging portions adjacent the die and parallel portions disposed remote from the die. Pivots are disposed at the intersection of each of the diverging portions with the respective parallel portion. The pivots allow the parallel portions to be moved closer together or further apart to shape the extruded thermoplastic foam as desired.

Other extrusion apparatuses include an expansion portion to expand a foam that is extruded from an extruder. A forming die is attached to an outlet of the extruder, wherein the forming die has a bore of greater cross-sectional area than the extruder outlet. In addition, a mechanical puller is disposed at an end of the forming die opposite the extruder outlet to continuously remove the extruded foam from the die. In another embodiment, the foam is extruded through a plurality of holes in an extruder outlet and the extruded foam is expanded upon exiting the plurality of holes.

### SUMMARY OF THE INVENTION

According to one aspect of the present invention, an extrusion die for forming polymeric foam sheets includes a first die body and a second die body. The extrusion die further includes a manifold within the first die body and the second die body, wherein the manifold includes an inlet to receive polymeric material. Still further, the extrusion die includes a die exit formed by opposing die lips in fluid communication with the manifold and a temperature control zone adjacent the die lips. The extrusion die further includes two generally planar shaping surfaces in proximity to the die exit and placed one above and one below the die exits. An adjustable shoe is disposed in proximity to the die exit on each side of the die exit and between the planar shaping surfaces.

According to another aspect of the present invention, an extrusion die for forming polymeric foam sheets includes a first die body, a second die body, and a manifold within the first die body and the second die body, wherein the manifold includes an inlet to receive polymeric material. The extrusion die further includes a die exit formed by opposing die lips in fluid communication with the manifold and a temperature control zone adjacent the die lips. The extrusion die further includes two generally planar shaping surfaces in proximity to the die exit and placed one above and one below the die exits. Still further, the extrusion die includes adjustable shoes in proximity to the die exit on each side of the die exit and between the planar shaping surfaces, wherein the adjustable shoes slope outwardly from the die exit. Edge restrictors are disposed adjacent each of the adjustable shoes and between the planar shaping surfaces, wherein the edge restrictors slope outwardly from the adjustable shoes.

Other aspects and advantages of the present invention will become apparent upon consideration of the following detailed description.

### BRIEF DESCRIPTION OF THE DRAWINGS

FIG. 1 is top and front isometric view of a first embodiment of an extrusion die of the present invention;

FIG. 2 is a front elevational view the extrusion die of FIG. 1;

FIG. 3 is a rear and top isometric view of the extrusion die of FIG. 1;

FIG. 4 is a top and rear isometric view of the extrusion die of FIG. 1 with a first die body removed therefrom;

FIG. 5 is a top and rear isometric view of the extrusion die of FIG. 1 with a first die body removed therefrom and illustrating a deckle attached to the extrusion die;

FIG. 6 is a cross-sectional view taken generally along the lines 6-6 of FIG. 1 omitting portions behind the cross-sectional plane;

FIG. 6A is a partial representation of FIG. 6 showing detail of lip inserts and forming box;

FIG. 7 is a top isometric view of a second embodiment of an extrusion die of the present invention with plates omitted for clarity;

FIG. 8 is a front elevational view of the embodiment of FIG. 7 having end portions of the die cut-away for clarity and including a general representation of calibrator plates; and

FIG. 9 is a top isometric view of a temperature control system for an extrusion die of the present invention.

### DETAILED DESCRIPTION OF THE PREFERRED EMBODIMENTS

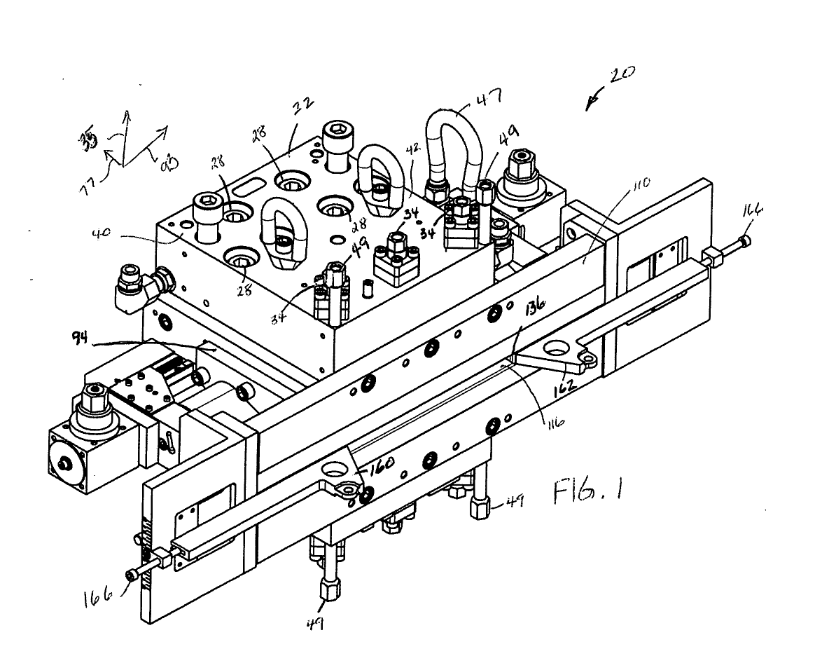

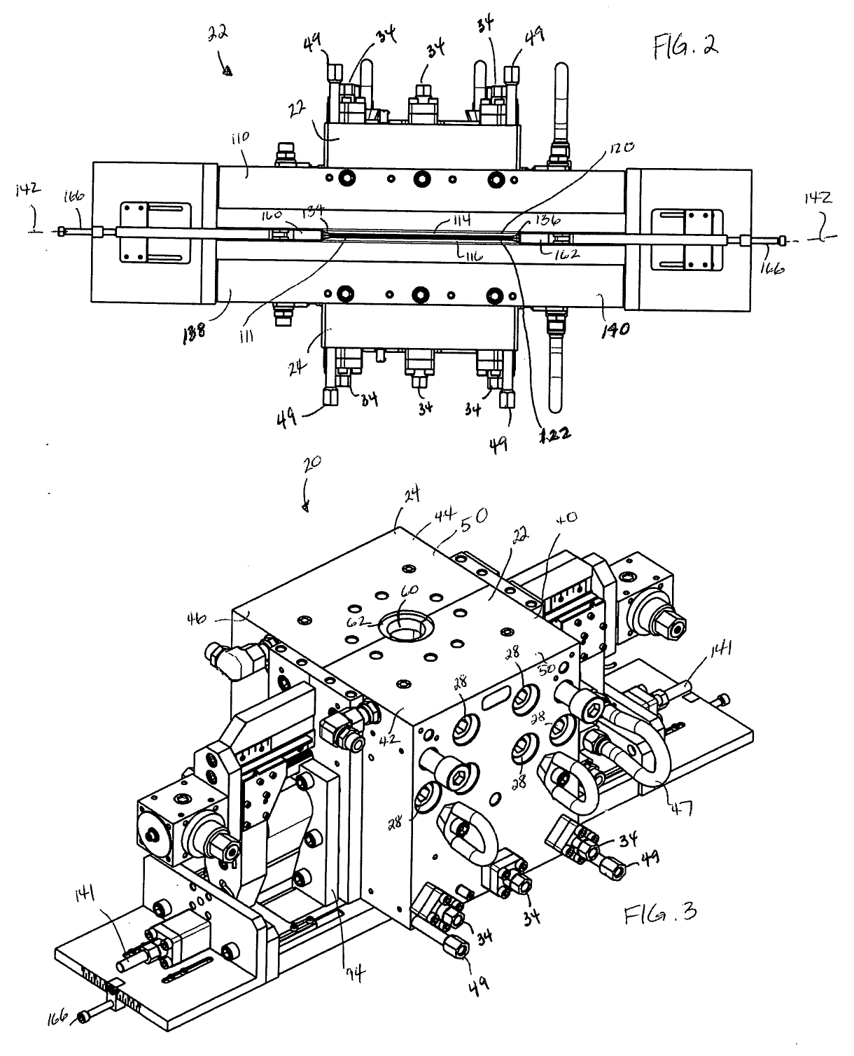

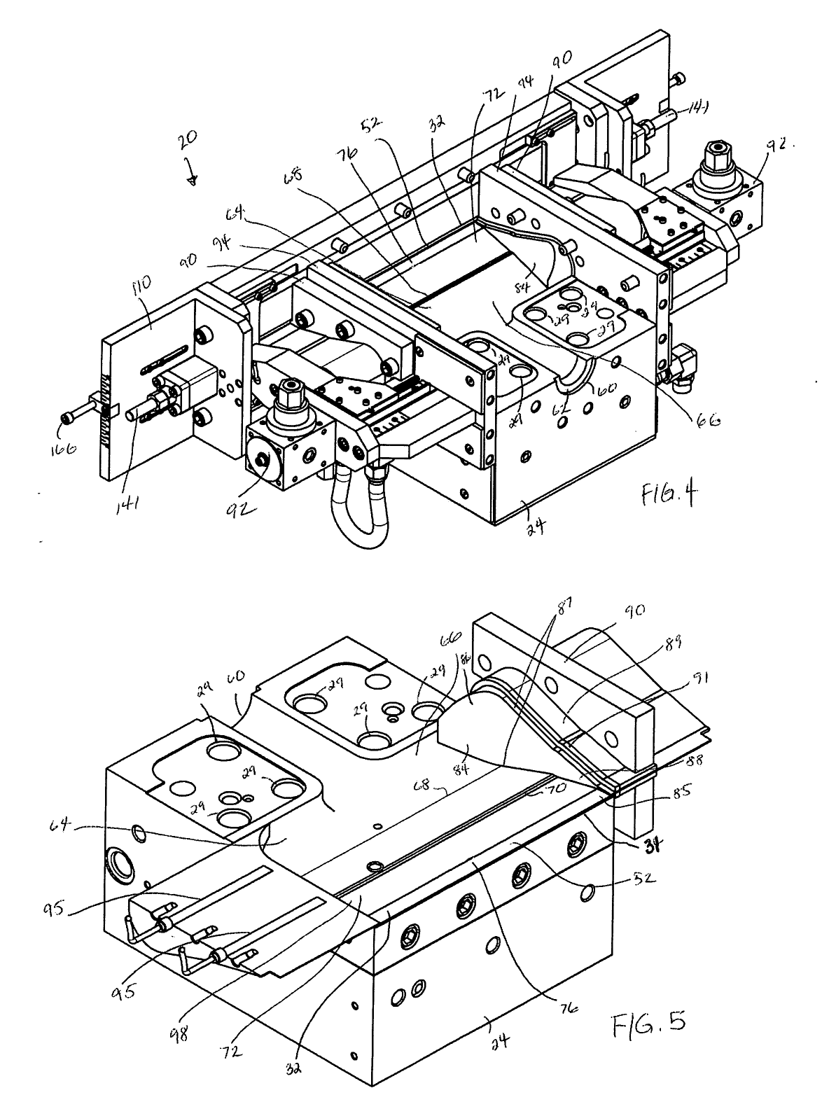

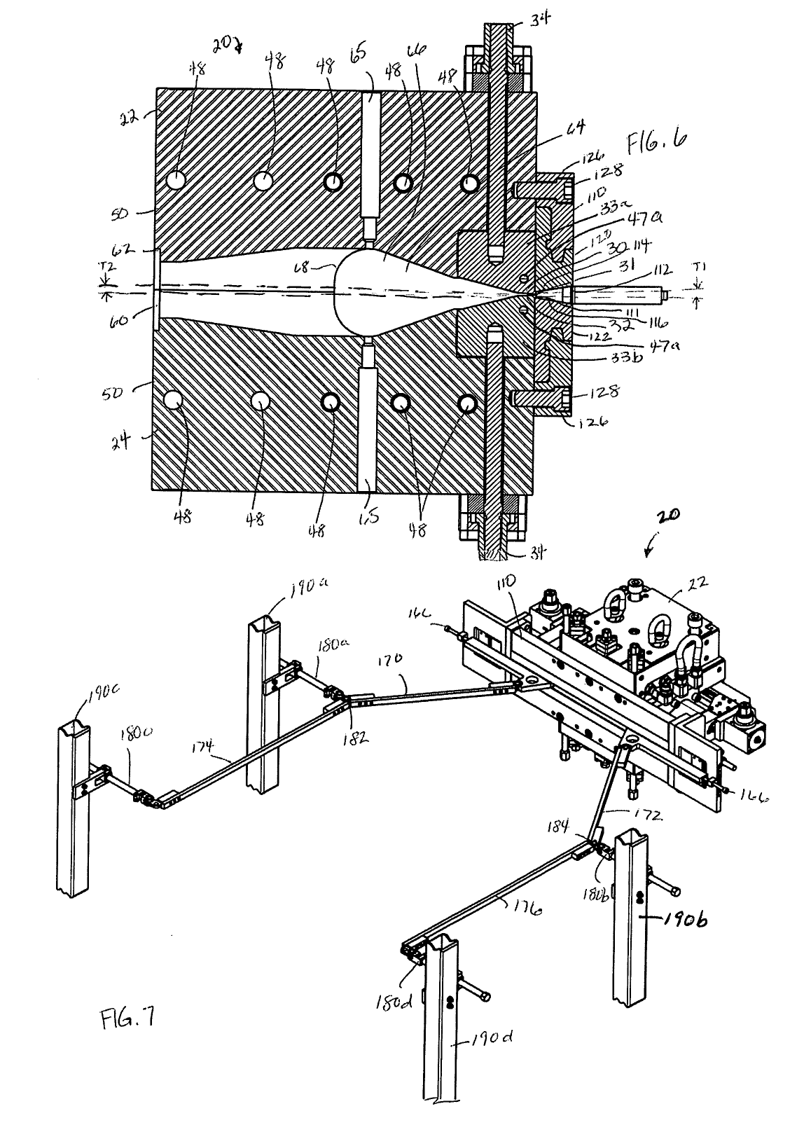

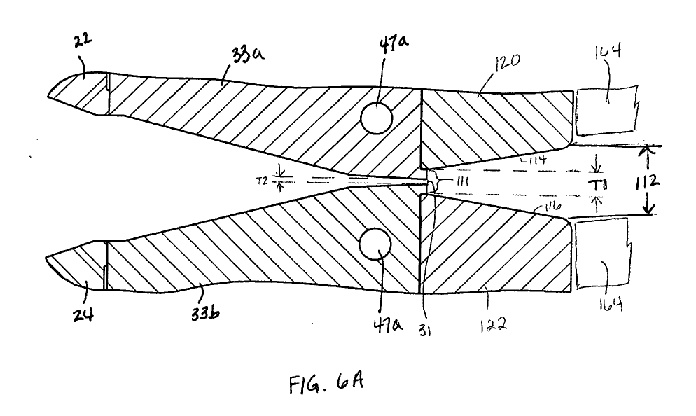

As shown in FIGS. 1-6, an extrusion die 20 includes first and second die bodies 22, 24. The first and second die bodies 22, 24 are joined together by a series of body bolts 28 extending through body bolt holes 29 in the first and second die bodies 22, 24. Referring to FIGS. 6 and 6A, the first die body 22 includes a first die lip 30 and the second die body 24 includes a second die lip 32. The first and second die lips 30, 32 communicate with one another to form a die exit 31 from which a flat sheet (not shown) of polymeric foam exits in a continuous fashion. The die exit 31 formed by the die lips 30, 32 preferably has an exit thickness in a y-direction 35 of between about 20/1000 inch and 1/10 inch. The die 20 includes opposing removable and adjustable lip inserts 33a, 33b adjacent the die lips 30, 32, respectively, wherein the lip inserts 33a, 33b are integral with the die lips 30, 32, respectively. A plurality of lip adjusters 34 extend upwardly from the first and second die bodies 22, 24, wherein the lip adjusters 34 adjust the lip inserts 33a, 33b to control a distance between the die lips 30, 32, and thus a thickness in the y-direction 35 of the die exit 31. The first die body 22 has two first die body ends 40, 42 and the second die body 24 has two similar second die body ends 44, 46 that are coextensive with the first die body ends 40, 42 when the first and second die bodies 22, 24 are attached to one another. The first and second die bodies 22, 24 further include upstream and downstream portions 50, 52.

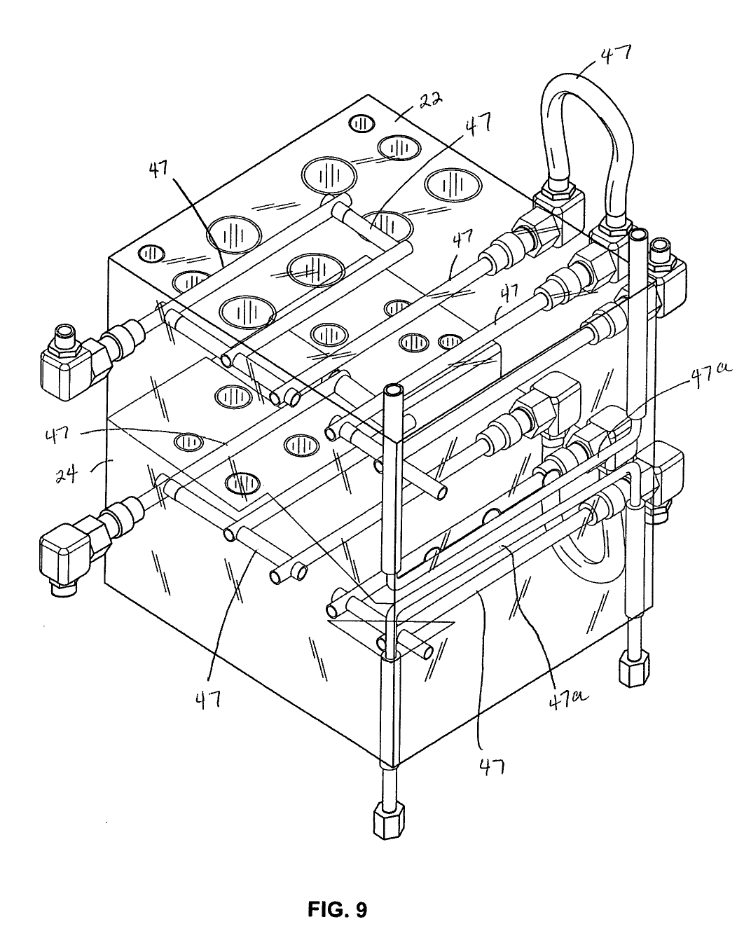

Preferably, as seen in FIG. 9, a temperature control fluid flows from cooling pipes 49 through a set of channels 47a to control a temperature of the die lips 30, 32 to a first temperature. In addition, a further set of channels 47 are disposed in communication with core holes 48 in the first and second die bodies 22, 24 for a temperature control fluid to flow through the channels 47 to heat or cool the die bodies 22, 24 to a second temperature. Terminal ends of the channels 47 are connected to supply lines that supply the liquid to the channels 47. Optionally, temperatures in the die lips 30, 32 and the remainder of the die 20 may be controlled separately to different temperatures for the first and second die bodies 22, 24, or upper and lower body zones. In one embodiment, the temperature control fluid may be an oil. Optionally, the die lips 30, 32 and die bodies 22, 24 could be heated electrically.

The second temperature is controlled to about 270° F.±20° F. to maintain the viscosity of the foam to allow the foam to flow freely through the die 20. The first temperature is preferably slightly above the glass transition temperature (T_{g}) of the final melt, and preferably about five degrees above T_{g} of the final melt. The first temperature is also controlled to about 40° F. less than the second temperature (about 230° F.) to increase the viscosity of the foam to allow the formation of a skin of more dense material on the foam board. The skin traps the blowing agent within the board, thereby controlling expansion of the foam. The first and second temperatures should be controlled to create a foam board of a preferred size, shape, and thickness.

A die inlet 60 is located proximate the upstream portions 50 of the first and second die bodies 22, 24. The die inlet 60 can be connected to any conventional extrusion device (not shown) by conventional means. A die inlet seal area 62 surrounds the die inlet 60 to enable the extrusion die 20 to form a fluid tight seal when attached to a conventional extruder.

The die inlet 60 is in fluid communication with a manifold 64 formed between the first and second die bodies 22, 24 and the manifold 64 is in fluid communication with the die exit 31 to allow molten polymeric foam to enter the die inlet 60 and exit the die exit 31. The manifold 64 includes temperature and/or pressure transducers 65 in communication therewith to measure a pressure in the manifold 64. The manifold 64 includes a cavity 66 defined by a back edge 68 of a secondary surface 72. In the area immediately downstream from the secondary surface 72 and upstream from the die exit 31 is a land portion 76. Each land portion 76 preferably has an angle of about 5 degrees for a total of about 10 degrees, although the land portion 76 could be flat. The land portion 76 also preferably has a length in a z-direction 77 between the secondary surface 72 and the die lips 30, 32 of about 0.5 inch, although other lengths may be used. The exact structure of the manifold 64, the cavity 66, the secondary surface 72, and the land portion 76 may be varied and may conform to any of a number of conventional designs for coat hanger-type extrusion dies, including coat hanger designs and the like. The shape and size of the land portion 76 may be varied to create a foam board of a desired shape and size.

The extrusion die 20 includes an internal deckle quill 84 disposed between the lip inserts 33a, 33b at a first end 85 of the first and second die lips 30, 32, wherein surfaces 87 of the deckle quill 84 are disposed adjacent the secondary surface 72, the land portion 76, and the die exit 31 to form a snug fit therebetween. The deckle quill 84 includes first and second edges 86, 88, wherein the first edge 86 is thicker than the second edge 88 and the deckle quill 84 tapers from the first edge 86 to the second edge 88. Adjacent the deckle quill 84 and disposed outside the first and second die bodies 22, 24 is a deckle seal 89. A deckle seal gasket 91 extends from the deckle seal 89 between the deckle quill 84 and the deckle seal 89. When the die 20 is fully assembled, the deckle seal 89 resides within a channel in an end plate 94 and the deckle seal gasket 91 is compressed between the first and second die bodies 22, 24 to create a leakproof seal around the deckle quill 84. A deckle seal plate 90 is disposed adjacent the deckle seal 89, wherein the deckle seal plate 90 retains the deckle quill 84 and deckle seal 89 in place between the lip inserts 33a, 33b. The deckle seal plate 90 is attached to the die bodies 22, 24 by bolts that extend through apertures in the deckle plate 90 and apertures in the end plate 94. An identical deckle quill 84 assembly is disposed between the lip inserts 33a, 33b at a second end 98 of the first and second die lips 30, 32 that are opposite the first end 85. The deckle quills 84 restrict material flow to a space between the deckle quills 84. The deckle quills 84 are adjustable in an x-direction 93 between die body ends 40, 42 of the first die body 22 and die body ends 44, 46 of the second die body 24 to control a width of the foam that is produced by the die exit 31. As seen in FIG. 4, first and second adjusters 92 are disposed adjacent the die body ends 40, 42, 44, 46. The adjusters 92 may be wheels, screws, any manual adjuster, a servo motor, or any other device known in the art for controlling adjustment of deckle quills 84.

The deckle quills 84 are controlled to yet another, third temperature, by electric heaters 95. Preferably, the deckle quills 84 are maintained at a temperature between the first and second temperatures to aid in forming a side seal.

As best seen in FIGS. 1, 2, 6, and 6A, a forming box 110 is disposed laterally adjacent the extrusion die 20, preferably adjacent the downstream portions 52 of the first and second die bodies 22, 24. The forming box 110 includes an inlet 111 disposed adjacent the die exit 31 of the extrusion die 20, wherein the inlet 111 of the forming box 110 has a thickness T1 that is preferably greater than a thickness T2 of the die exit 31. The difference in thicknesses T1 and T2 allows an expansion of the foam immediately as the foam exits the die exit 31 into the forming box 110. The forming box 110 further includes an outlet 112 formed by first and second opposing planar shaping surfaces 114, 116 that extend outward from the inlet 111 of the forming box 110 to the outlet 112 of the forming box 110. The shaping surfaces 114, 116 each have an angle between about 0 degrees and 75 degrees from a horizontal, creating an angle of between about 0 degrees and 150 degrees. Preferably, the shaping surfaces 114, 116 are each at least 5 degrees from the horizontal, creating an angle of at least 10 degrees sloping outwardly from the die exit 31. The shaping surfaces 114, 116 allow for controlled expansion of the foam in a vertical direction by controlling the coefficient of friction between the surfaces 114, 116 and the extruded foam and by controlling the rate of heat transfer between the extruded foam and the surfaces 114, 116. A coefficient of friction between the surfaces 114, 116 and the foam is minimized by the smoothness of the surfaces 114, 116 and the nature of the material utilized for the surfaces 114, 116. Preferably, the rate of heat transfer from the extruded foam to the surfaces 114, 116 is relatively slow to allow a controlled cooling of the foam. The forming box 110 further includes upper and lower inserts 120, 122 surrounding the outlet 112, wherein the upper and lower sizing inserts 120, 122 are preferably, although not necessarily, stationary and not adjustable relative to the outlet 112 or the die exit 31. The forming box 110 further includes the sizing inserts 120, 122, which are disposed adjacent the shaping surfaces 114, 116 and a clamp bar 126 disposed adjacent the sizing inserts 120, 122. Bolts 128 secure the forming box 110 to the die 20 through the clamp bar 126.

First and second adjustable side shoes 134, 136 are disposed at opposite ends 138, 140 of the forming box 110 between the planar shaping surfaces 114, 116. The adjustable side shoes 134, 136 each extend from the die exit 31 toward the outlet 112, wherein the adjustable side shoes 134, 136 are adjustable via one or more adjusters 141 (FIGS. 3 and 4) along a longitudinal axis 142 of the forming box 110. The side shoes 134, 136 are disposed at an outward angle of between about 0 degrees and about 75 degrees with respect to the longitudinal axis 142, and more preferably at least 15 degrees with respect to the longitudinal axis 142 wherein the angle may be varied. As discussed above, the adjusters 141 may be in the form of a wheel, a manual adjuster, a servo motor, or any other control known in the art.

The side shoes 134, 136 control the expansion of the foam as the foam moves through the die exit 31 into the forming box 110 through the inlet 111 thereof. This control over the expansion of the foam allows regulation of the formation of the foam as well as allowing the formation of more precise pore sizes in the foam and a more desirable foam density.

Preferably, although not necessarily, first and second edge restrictors 160, 162 are disposed between the forming box 110 and calibrator plates 164 (FIG. 8). The edge restrictors 160, 162 extend from the forming box 110 toward the calibrator plates 164 in a manner similar to the adjustable side shoes 134, 136. The edge restrictors 160, 162 are similarly adjustable via one or more adjusters 166 along the longitudinal axis 142 of the forming box 110. The edge restrictors 160, 162 are preferably disposed at an angle of between about 0 degrees and about 75 degrees with respect to the longitudinal axis 142 and more preferably at an angle of at least 15 degrees with respect to the longitudinal axis 142. The angle of the edge restrictors 160, 162 may be varied and may or may not be the same as the angle of the side shoes 134, 136. As with the adjusters 141 for the side shoes 134, 136, the adjusters 166 may be in the form of a wheel, a manual adjuster, a servo motor, or any other control known in the art.

In another embodiment, two forming boxes 110 may be attached sequentially to the die 20 to allow for increased adjustability and increased controllability. Preferably, two forming boxes 110 would be utilized for extruding thicker foam boards to control the size and shape of the extruded board for a greater distance than with a single forming box 110.

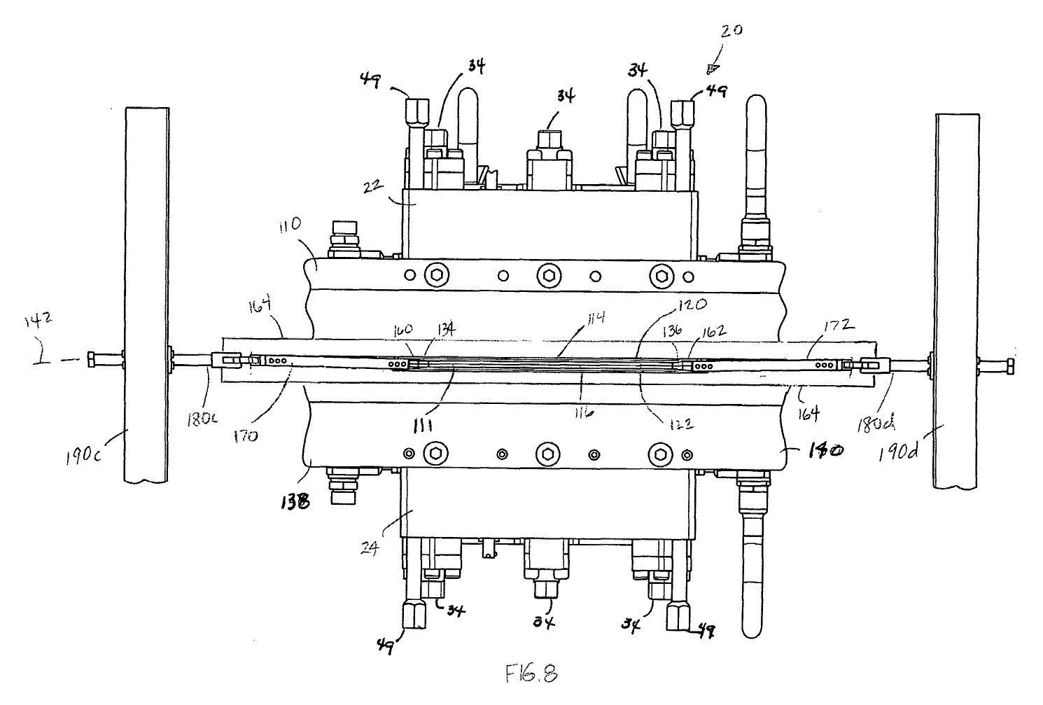

As seen in FIGS. 7 and 8, in an alternate embodiment, the edge restrictors 160, 162 may include angled extensions 170, 172 extending respectively therefrom. The angled extensions 170, 172 may be angled at the same angle as the edge restrictors 160, 162, but alternatively may be at a different angle. Additional extensions 174, 176 are pivotally connected to the angled extensions 170, 172, respectively. Adjusters 180a, 180b extend between pivotal connections 182, 184 between the angled extensions 170, 172 and the additional extensions 174, 176, and stationary posts 190a0, 190b, wherein the adjusters 180a, 180b are fixedly attached to the posts 190a, 190b. Adjusters 180c, 180d extend between the extensions 174, 176 and stationary posts 190c, 190d, respectively. The adjusters 180a-180d allow adjustment of the angles of the extensions 170, 172, 174, 176 to change the shape and/or size of an extruded foam board. The calibrator plates 164 are disposed atop and below the extensions 170, 172, 174, 176 to prevent vertical expansion of foam.

The side shoes 134, 136 and edge restrictors 160, 162 are angled to allow the extruded foam to expand in a controlled manner while the foam expands within the calibrator plates 164 downstream from the extrusion die 20. The side shoes 134, 136 and edge restrictors 160, 162 also aid in squaring off edges of an extruded foam board, thus decreasing the amount of trimming needed. The calibrator plates 164 then maintain the thickness of the foam board created by the extrusion die 20. In particular, the calibrator plates 164 are large plates downstream of the forming box 110 that allow the foam to cool to maintain a preferred size and shape of the foam after the foam has passed the edge restrictors 160, 162 and there are no longer any side constraints to prevent the foam from further expansion. The calibrator plates control expansion of the foam by controlling the coefficient of friction between the calibrator plates 164 and the extruded foam and controlling the rate of heat transfer between the extruded foam and the calibrator plates 164. As with the shaping surfaces 114, 116, the coefficient of friction between the calibrator plates 164 and the foam is minimized by the smoothness of the calibrator plates 164 and the nature of the material utilized for the calibrator plates 164. Preferably, the rate of heat transfer from the extruded foam to the calibrator plates 164 is also relatively slow to allow a controlled cooling of the foam. The calibrator plates 164 may be any standard calibrator plates known in the industry.

The extrusion die 20, side shoes 134, 136, and edge restrictors 160, 162, as discussed in detail herein, preferably form foam boards having thicknesses between about 0.5 inch and 6 inches. The thicker the board to be extruded, the more important the adjustability of the edge restrictors 160, 162 and further extensions 170, 172, 174, 176 becomes due to the increased need for edge control of a thicker foam board that takes longer to cool and thus continues to expand. For this reason, if very thin boards are formed, the edge restrictors 160, 162 may not be necessary. Edge control is very important because it controls both the cell size and cell shape and also decreases the amount of scrap created. It is not only important to have edge control when the foam exits the die 20, but also downstream of the die 20. The extensions 170, 172, 174, 176 provide edge control and the calibrator plates 164 prevent vertical expansion downstream of the forming box 110, which become more important as the board gets thicker. In particular, thicker board take longer to cool and therefore, a center of the board remains warm after extrusion and blowing agents in the extruded foam create gas that expands the material. The calibrator plates 164 control expansion of the board downstream of the forming box 110 so that the board does not expand unevenly.

In the present invention, the deckle quills 84, the side shoes 134, 136, the edge restrictors 160, 162, calibrator plates 164, and extensions 170, 172, 174, 176, are all adjustable on the fly. Specifically, any of such components may be adjusted while the die 20 is running and without shutting down the process. This is particularly important because shut down and start up of the process can take hours and produce a lot of scrap. Therefore, adjustment on the fly saves time and money during production. Furthermore, the side shoes 134, 136, the inserts 120, 122, and the edge restrictors 160, 162 may be removed and replaced by other similar components to allow for adjustability in the forming box 110 to account for modification of the extruded foam board, all without shutting down the process.

### INDUSTRIAL APPLICABILITY

The preceding embodiments of extrusion dies of the present application are for use in extruding polymeric foam sheets. The deckle quills, side shoes, edge restrictors, calibrator plates, and extensions alone or in combination create systems that, when used alone or in any combination, are used to control the width and thickness of a foam sheet formed by an extrusion die.

Numerous modifications to the present invention will be apparent to those skilled in the art in view of the foregoing description. Accordingly, this description is to be construed as illustrative only and is presented for the purpose of enabling those skilled in the art to make and use the invention and to teach the best mode of carrying out same. The exclusive rights to all modifications which come within the scope of the appended claims are reserved.

I/we claim:

1. An extrusion die for forming polymeric foam sheets comprising:
a first die body and a second die body;
a manifold within the first die body and the second die body, the manifold having an inlet to receive polymeric material;
a die exit formed by opposing die lips in fluid communication with the manifold;
a temperature control zone adjacent the die lips;
two generally planar shaping surfaces in proximity to the die exit and placed one above and one below the die exit; and
adjustable shoes in proximity to the die exit on each side of the die exit and between the planar shaping surfaces.

2. The extrusion die of claim 1, further including lip inserts that form the die lips and die exit, wherein the lip inserts form the temperature control zone.

3. The extrusion die of claim 2, wherein the lip inserts are removable and adjustable.

4. The extrusion die of claim 3, wherein the lip inserts are control to a temperature of about 5° F. about a glass transition temperature of a foam melt.

5. The extrusion die of claim 2, further including a second temperature control zone adjacent the manifold.

6. The extrusion die of claim 5, wherein the second temperature control zone is control to a temperature of between about 250° F. and about 290° F.

7. The extrusion die of claim 1, further including a forming box in which the planar shaping surfaces and adjustable shoes are located and wherein the adjustable shoes slope outwardly from the die exit.

8. The extrusion die of claim 7, wherein the adjustable shoe is adjustable along a longitudinal axis of the forming box.

9. The extrusion die of claim 8, further including edge restrictors downstream from the adjustable shoes and between the planar shaping surfaces.

10. The extrusion die of claim 9, wherein the edge restrictors are adjustable along a longitudinal axis of the forming box.

11. The extrusion die of claim 10, wherein the edge restrictors slope outwardly from the adjustable shoes.

12. The extrusion die of claim 1, further including an internal deckle that is adjustable.

13. The extrusion die of claim 12, wherein the deckle is shaped so that no dead spot is created in the manifold when material is flowing therethrough.

14. An extrusion die for forming polymeric foam sheets comprising:
a first die body and a second die body;
a manifold within the first die body and the second die body, the manifold having an inlet to receive polymeric material;
a die exit formed by opposing die lips in fluid communication with the manifold;
a temperature control zone adjacent the die lips;
two generally planar shaping surfaces in proximity to the die exit and placed one above and one below the die exit;
adjustable shoes in proximity to the die exit on each side of the die exit and between the planar shaping surfaces, wherein the adjustable shoes slope outwardly from the die exit; and
edge restrictors adjacent each of the adjustable shoes and between the planar shaping surfaces, wherein the edge restrictors slope outwardly from the adjustable shoes.

15. The extrusion die of claim 14, further including lip inserts that form the die lips and die exit, wherein the lip inserts form the temperature control zone.

16. The extrusion die of claim 15, wherein the lip inserts are removable and adjustable.

17. The extrusion die of claim 16, wherein the lip inserts are control to a temperature of about 5° F. about a glass transition temperature of a foam melt.

18. The extrusion die of claim 15, further including a second temperature control zone adjacent the manifold.

19. The extrusion die of claim 18, wherein the second temperature control zone is control to a temperature of between about 250° F. and about 290° F.

20. The extrusion die of claim 14, further including a forming box in which the planar shaping surfaces and adjustable shoes are located.

21. The extrusion die of claim 20, wherein the adjustable shoes are changeable and adjustable along a longitudinal axis of the forming box.

22. The extrusion die of claim 23, wherein the forming box includes top and bottom inserts that are changeable and adjustable.

23. The extrusion die of claim 14, wherein the edge restrictors are disposed downstream from the adjustable shoes.

24. The extrusion die of claim 23, wherein the edge restrictors are changeable and adjustable along a longitudinal axis of the forming box.

25. The extrusion die of claim 24, wherein the edge restrictors slope outwardly from the adjustable shoes.

26. The extrusion die of claim 25, further including first and second internal deckles disposed at opposing sides of the die adjacent first and second die lips forming a die exit.

27. The extrusion die of claim 25, further including an internal deckle that is adjustable.

28. The extrusion die of claim 27, wherein the deckle is shaped so that no dead spot is created in the manifold when material is flowing therethrough.
